(19) United States
(12) Patent Application Publication
(10) Pub. No.: US 2020/0178568 A1
(43) Pub. Date: Jun. 11, 2020

(54) METHOD OF PRODUCING PET FOOD

(71) Applicant: Unicharm Corporation, Ehime (JP)

(72) Inventors: Masaki Shiota, Itami-shi (JP); Munehiro Usui, Itami-shi (JP); Hidetaka Oyama, Itami-shi (JP); Hayato Nishitani, Itami-shi (JP)

(73) Assignee: Unicharm Corporation, Ehime (JP)

(21) Appl. No.: 16/703,063

(22) Filed: Dec. 4, 2019

(30) Foreign Application Priority Data
Dec. 7, 2018 (JP) 2018-230263

(51) Int. Cl. A23K 40/30; A23K 40/20; A23K 50/42; A23K 40/25

(52) U.S. Cl. CPC A23K 40/30; A23K 40/25; A23K 50/42; A23K 40/20

(57) ABSTRACT

There is provided a method of producing pet food including a base substance and a coating part that coats a part of the base substance, the method including: (a) a step of processing a coating part forming composition having a composition different from that of the base substance, at a first temperature (T1); (b) a step of processing the coating part forming composition at a second temperature (T2), after the step (a); (c) a step of processing the coating part forming composition at a third temperature (T3), after the step (b); (d) a step of coating a part of the base substance with the coating part forming composition obtained in the step (c); and (e) a step of solidifying the coating part forming composition with which the part of the base substance is coated, in which there is a relationship of the first temperature (T1)>the third temperature (T3)>the second temperature (T2).

### BACKGROUND OF THE INVENTION

### Field of the Invention

The present invention relates to a method of producing pet food. Priority is claimed on Japanese Patent Application No. 2018-230263, filed on Dec. 7, 2018, the content of which is incorporated herein by reference.

### Description of Related Art

In pet food, various ideas are made so that pets can enjoy eating, that is, palatability improves.

For example, Japanese Patent No. 4689932 discloses animal food including a shell component of a cereal base and a soft internal component including a lipid component, in which palatability is improved by making the animal food into a double structure in which the soft internal component is completely surrounded by the shell component.

### SUMMARY OF THE INVENTION

However, in the animal food described in Japanese Patent No. 4689932, since the soft internal component is completely surrounded by the shell component, in view of appearance, it is poor in visual change and visual interest cannot be raised. In addition, a food texture at the beginning of chewing is uniform and a change depending on the food texture is poor.

In order to impart changes in the appearance and the food texture to the pet food, for example, it is conceivable to coat a part of the pet food with a cream-like composition. However, in a case where a part of a base substance of the pet food is coated with the cream-like composition, bleeding or spreading of the cream-like composition to the base substance may occur and the appearance may be impaired in some cases. In addition, in a case where a coated range is excessive due to the bleeding or spreading of the cream-like composition to the base substance, there is a concern that pet food that deviates from the intended nutritional design (for example, design as a comprehensive nutritious food) may be produced.

Therefore, an object of the present invention is to provide a method of producing pet food by which bleeding or spreading to the base substance can be prevented from occurring and a coating part with good shape retention property can be formed.

The present invention includes the following aspects.

(1) A method of producing pet food including a base substance and a coating part that coats a part of the base substance, in which a part of the base substance is exposed and a component composition of the base substance and a component composition of the coating part are different from each other, the method including:

(a) a step of processing a coating part forming composition having a composition different from that of the base substance, at a first temperature (T1);

(b) a step of processing the coating part forming composition at a second temperature (T2), after the step (a);

(c) a step of processing the coating part forming composition at a third temperature (T3), after the step (b);

(d) a step of coating a part of the base substance with the coating part forming composition obtained in the step (c); and

(e) a step of solidifying the coating part forming composition with which the part of the base substance is coated,

in which there is a relationship of the first temperature (T1)>the third temperature (T3)>the second temperature (T2).

(2) The method of producing pet food according to (1),

in which the first temperature (T1) is a temperature equal to or higher than a melting point of the coating part forming composition,

the second temperature (T2) is in a temperature range of 42° C. to 58° C., and

the third temperature (T3) is in a temperature range of 42.5° C. to 60° C.

(3) The method of producing pet food according to (1) or (2),

in which the coating part forming composition contains oil and fat and a powder ingredient.

(4) The method of producing pet food according to any one of (1) to (3),

in which the coating part forming composition contains hardened oil and fat.

(5) The method of producing pet food according to any one of (1) to (4),

in which a temperature difference between the second temperature (T2) and the third temperature (T3) is in a range of 0.5° C. to 5° C.

(6) The method of producing pet food according to any one of (1) to (5),

in which a temperature difference between the first temperature (T1) and the second temperature (T2) is in a range of 7° C. to 20° C.

(7) The method of producing pet food according to any one of (1) to (6),

in which a height from a surface of the base substance to a topmost part of the coating part is 0.1 to 2 mm.

(8) The method of producing pet food according to any one of (1) to (7),

in which the base substance is granular.

(9) The method of producing pet food according to (8),

in which the base substance is a puffed granule.

According to the present invention, there is provided a method of producing pet food by which bleeding or spreading to the base substance can be prevented from occurring and a coating part with good shape retention property can be formed.

### BRIEF DESCRIPTION OF THE DRAWINGS

FIG. 1 shows an example of pet food produced by a method of producing pet food according to an embodiment of the present invention.

### DETAILED DESCRIPTION OF THE INVENTION

In the present specification, the term “pets” indicates animals that have been bred by people. In a narrower sense, pets are animals being cared for by their owners. Further, the term “pet food” indicates feed for pets. The pet food of the present invention can be sold as “animal feed” or “animal food”.

In the present specification, the term “dry type pet food” refers to food granules having a moisture content of approximately 6% by mass. The moisture content of dry type food granules is approximately 3% to 12% by mass in general, and preferably about 10% by mass or less.

In the present specification, the term “soft type pet food” refers to pet food having a moisture content of approximately 15% to 35% by mass.

Method of Measuring Major Axis, Minor Axis, and Thickness of Pet Food

In the present specification, regarding an average major axis and an average minor axis of pet food, when the pet food placed on a horizontal table is viewed from above, major axes and minor axes thereof are measured with a caliper, and average values thereof are taken as the average major axis and the average minor axis. In addition, regarding a thickness of pet food, a thickness from a lower surface (lower end) to an upper surface (upper end) of pet food placed on a horizontal table is measured.

Method of Measuring Height and Width of Coating Part

In the present specification, regarding a height of a coating part of pet food, a height from a surface of a base substance to the topmost part of the coating part in the pet food placed on a horizontal table is measured with a caliper. In addition, regarding a width of the coating part of the pet food, a width of the coating part of the pet food placed on a horizontal table is measured with a caliper.

Method of Producing Pet Food

According to an embodiment of the present invention, a method of producing pet food is a method of producing pet food including a base substance and a coating part that coats a part of the base substance, in which a part of the base substance is exposed and a component composition of the base substance and a component composition of the coating part are different from each other. The method of producing pet food according to the present embodiment includes (a) a step of processing a coating part forming composition having a composition different from that of the base substance, at a first temperature (T1); (b) a step of processing the coating part forming composition at a second temperature (T2), after the step (a); (c) a step of processing the coating part forming composition at a third temperature (T3), after the step (b); (d) a step of coating a part of the base substance with the coating part forming composition obtained in the step (c); and (e) a step of solidifying the coating part forming composition with which the part of the base substance is coated.

The first temperature (T1), the second temperature (T2), and the third temperature (T3) have a relationship of the first temperature (T1)>the third temperature (T3)>the second temperature (T2).

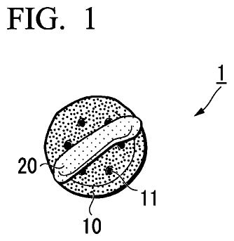

FIG. 1 is a view showing an example of pet food produced by the method of producing pet food according to the present embodiment. In pet food 1, a part of abase substance 10 having a round shape is coated with a coating part 20. According to the method of producing pet food according to the present embodiment, a shape retention property of the coating part 20 is improved, and the coating part 20 can be easily formed into a desired shape. In addition, pet food in which the height of the coating part 20 (the height from the surface of the base substance 10 to the topmost part of the coating part 20) is moderately maintained and appearance is excellent can be produced.

In FIG. 1, a reference sign “11” represents a recessed part formed in the base substance 10. In the pet food produced by the production method according to the present embodiment, the recessed part 11 may be provided or may not be provided, and it is preferable that the recessed part 11 is provided from a viewpoint that the coating part 20 is difficult to peel off.

Step (a)

The step (a) is a step of processing the coating part forming composition having a composition different from that of the base substance, at the first temperature (T1).

Coating Part Forming Composition

The coating part forming composition is a composition for forming a coating part. The coating part forming composition has a component composition different from that of the component composition of the base substance, which will be described later, in order to form a coating part having a component composition different from that of the base substance.

The coating part forming composition may have a component composition different from that of the base substance, and known ingredients of pet food can be appropriately used. The coating part forming composition may contain, for example, oil and fat and a powder ingredient. For example, the oil and fat, the powder ingredient, and optional ingredients such as an excipient and a nutrient ingredient may be mixed to be used as the coating part forming composition.

The oil and fat may be vegetable oil and fat, animal oil and fat, or a combination of the vegetable oil and fat and the animal oil and fat. The oil and fat is preferable to contain hardened oil and fat from a viewpoint that the shape retention property of the coating part is improved. The “hardened oil and fat” refers to oil and fat of which a melting point is increased by performing hydrogen addition (hydrogenation) to oil and fat that has a high proportion of unsaturated fatty acids and is liquid at room temperature and increasing a proportion of saturated fatty acids. The hardened oil and fat is usually in a solid state at room temperature. The hardened oil and fat may be vegetable oil and fat, animal oil and fat, or a combination of the vegetable oil and fat and the animal oil and fat. As the hardened oil and fat, it is preferable to use extremely hardened oil and fat (having a melting point of 56.5° C. to 60.5° C.) from a viewpoint that the shape retention property of the coating part is improved.

As the oil and fat, for example, those having a high melting point (approximately 45° C. to 65° C. and preferably approximately 56.5° C. to 60.5° C.) and those having a low melting point (approximately 20° C. to 45° C. and preferably approximately 30° C. to 40° C.) are preferably used in combination. In a case where only those having the high melting point are used, the oil and fat is difficult to be dissolved or decomposed in the body when ingested. On the other hand, when only those having the low melting point are used, there are concerns that processability is poor and the oil and fat will melt when the temperature is high. When those having the high melting point and those having the low melting point are used in combination, it is possible to obtain a composition that has good processability and is easily dissolved when eaten. Examples of such a combination include a combination of vegetable oil and fat and hardened oil and fat. Alternatively, refined beef tallow, refined pork tallow, chicken tallow, sheep tallow, horse tallow, fish oil, fatty acids (such as linoleic acid and linolenic acid), butter, and the like may be used instead of the vegetable oil and fat or together with the vegetable oil and fat. Preferred examples of the vegetable oil and fat include palm oil and palm fractionated oil.

The powder ingredient is blended to lower a fluidity of the coating part forming composition to form a raised coating part. As examples of the powder ingredient, all powder ingredients usable for pet food can be used without any particular limitation. Examples of powder ingredients include power of cereals (such as corn, wheat, rice, corn gluten meal, wheat bran, bread crumbs, barley, buckwheat, and rye), potatoes (such as sweet potatoes and potatoes), beans (such as round soybeans and defatted soybeans), starches (such as wheat starch, corn starch, rice starch, potato starch, tapioca starch, sweet potato starch, sago starch, and modified starch), meats (such as livestock such as chicken, beef, pork, and venison; liver, beef muscle, pork ears, and chicken fillet which represent part thereof; chicken meal, pork meal, beef meal, mixed meal of these, and meat extract which are processed product thereof), seafoods (such as fish such as tuna, bonito and horse mackerel; crustaceans such as shrimp and crab, molluscs such as octopus and squid, shellfish such as scallops and fish; fish meal, fish extract, and Katsuobushi which are processed product thereof; and small fish representing a form thereof, anchovy, a white fish representing a quality thereof, and tuna Chiai representing a part thereof), vegetables, seeds, mushrooms, fruits, algae, eggs, sugars, milks, and others (herbs, yeast, cellulose, and the like).

Preferred examples of the powder ingredient include soybean powder. Among these, concentrated soy protein is preferable, and those obtained by being heat treated in consideration of digestion are more preferable. In addition, pregelatinized wheat flour, separated soy protein, protein hydrolyzate, brewer's yeast powder, cheese powder, milk powder, seafood powder, amino acid powder, meats, beans, rice flour, malt powder, nucleic acid, and the like may be used instead of the soybean powder of together with the soybean powder. It is preferable to use a powder ingredient that is compatible with the oil and fat. The pulverized particle size of the powder ingredient is not particularly limited, but the maximum pulverized particle size is preferably 400 μm or smaller, and the average pulverized particle size is more preferably 100 μm or smaller.

The coating part forming composition may contain additives such as various excipients, vitamins, inorganic salts, amino acids, acidulants, seasonings, flavors, coloring agents, preservatives, emulsifiers, and antioxidants.

The coating part forming composition can be prepared by appropriately selecting the ingredients described above and mixing them at a desired mixing ratio.

As a mixing example of the coating part forming composition, a total of 5% to 70% by mass of oil and fat having the low melting point (such as vegetable oil and fat), a total of 3% to 40% by mass of oil and fat having the high melting point (such as the hardened oil and fat), a total of 5% to 70% by mass of powder ingredients, and a total of 2.5% to 35% by mass of excipients (such as dextrin, starches, monosaccharides, and oligosaccharides) may be used.

Processing at First Temperature (T1)

The first temperature (T1) refers to a temperature higher than the second temperature (T2) and the third temperature (T3), which will be described later. The first temperature (T1) is preferably a temperature equal to or higher than the melting point of the coating part forming composition. When processing at the first temperature (T1) is performed, the coating part forming composition can be made into a liquid state, which is preferable. In the present specification, the term “melting point of coating part forming composition” refers to a temperature at which sufficient fluidity is imparted to the coating part forming composition, and may not be a temperature at which all the components mixed in the coating part forming composition are melted. For example, in a case where the coating part forming composition contains oil and fat, the melting point of the coating part forming composition may be a melting point of the oil and fat. In a case where the coating part forming composition contains two or more kinds of oils and fats which have different melting points from each other, the first temperature (T1) may be a temperature equal to or higher than melting points of all oils and fats or may also be a temperature equal to or higher than a melting point of oil and fat which is mixed in a larger amount. In a case where the coating part forming composition contains the hardened oil and fat, the first temperature (T1) may be a temperature equal to or higher than a melting point of the hardened oil and fat.

The first temperature (T1) can be appropriately selected according to the composition of the coating part forming composition. Examples thereof include 55° C. or higher, 57° C. or higher, 58° C. or higher, 59° C. or higher, or 60° C. or higher. An upper limit of the first temperature (T1) is not particularly limited, and is preferably 70° C. or lower from a viewpoint of preventing the coating part forming composition from deteriorating. The first temperature (T1) may be, for example, 68° C. or lower or 65° C. or lower. Examples of the first temperature (T1) include 55° C. to 70° C., 57° C. to 70° C., 58° C. to 68° C., 59° C. to 65° C., or 60° C. to 65° C.

The processing at the first temperature (T1) may be performed while stirring the coating part forming composition with a Homo Disper or a homogenizer. In addition, among the ingredients in the coating part forming composition, first, the oil and fat are heated to the first temperature (T1), and then the ingredients other than the oil and fat are added. Accordingly, the coating part forming composition is prepared. Then, the processing at the first temperature (T1) may be performed by continuing the stirring at the first temperature (T1).

The processing time at the first temperature (T1) is not particularly limited, and can be appropriately selected according to the composition and the amount of the coating part forming composition. Examples of the processing time include 1 minute or longer, 5 minutes or longer, or 10 minutes or longer. An upper limit of the processing time is not particularly limited, and examples thereof include 100 minutes or shorter, 60 minutes or shorter, or 40 minutes or shorter from the viewpoint of preventing the coating part forming composition from deteriorating and the viewpoint of work efficiency.

Examples of the processing time at the first temperature (T1) include 1 to 100 minutes, 5 to 60 minutes, or 10 to 40 minutes.

Step (b)

The step (b) is a step of processing the coating part forming composition at the second temperature (T2), after the step (a).

The second temperature (T2) refers to a temperature lower than the first temperature (T1) and the third temperature (T3) to be described later. The second temperature (T2) is not particularly limited as long as it is lower than the first temperature (T1) and the third temperature (T3) to be described later. From the viewpoint of improving the shape retention property of the coating part, a temperature range of 42° C. to 58° C. is preferable, a temperature range of 45° C. to 56° C. is more preferable, a temperature range of 48° C. to 55° C. is still more preferable, and a temperature range of 50° C. to 54° C. is particularly preferable.

In addition, the second temperature (T2) is preferably 7° C. to 20° C. lower, more preferably 7° C. to 15° C. lower, and still more preferably 8° C. to 12° C. lower than the first temperature (T1), from the viewpoint of improving the shape retention property of the coating part.

The processing time at the second temperature (T2) can be appropriately selected according to the composition and the amount of the coating part forming composition. Examples of the processing time include 5 seconds or longer, 30 seconds or longer, 1 minute or longer, 5 minutes or longer, or 10 minutes or longer. An upper limit of the processing time is not particularly limited, and examples thereof include 60 minutes or shorter or 40 minutes or shorter, from the viewpoint of preventing the coating part forming composition from deteriorating and the viewpoint of work efficiency. Examples of the processing time at the second temperature (T2) include 5 seconds to 60 minutes, 30 seconds to 60 minutes, or 10 to 40 minutes.

Step (c)

The step (c) is a step of processing the coating part forming composition at the third temperature (T3), after the step (b).

The third temperature (T3) refers to a temperature lower than the first temperature (T1) and higher than the second temperature (T2). The third temperature (T3) is not particularly limited as long as it is lower than the first temperature (T1) and higher than the second temperature (T2). From the viewpoint of improving the shape retention property of the coating part, a temperature range of 42.5° C. to 60° C. is preferable, a temperature range of 47° C. to 58° C. is more preferable, a temperature range of 50° C. to 58° C. is still more preferable, and a temperature range of 52° C. to 57° C. is particularly preferable.

In addition, the third temperature (T3) is preferably 0.5° C. to 5° C. higher, more preferably 1° C. to 3° C. higher, and still more preferably 2° C. to 2.5° C. higher than the second temperature (T2), from the viewpoint of improving the shape retention property of the coating part.

The processing time at the third temperature (T3) can be appropriately selected according to the composition and the amount of the coating part forming composition. Examples of the processing time include 5 seconds or longer, 30 seconds or longer, 1 minute or longer, 5 minutes or longer, or 10 minutes or longer. An upper limit of the processing time is not particularly limited, and examples thereof include 60 minutes or shorter or 40 minutes or shorter, from the viewpoint of preventing the coating part forming composition from deteriorating and the viewpoint of work efficiency. Examples of the processing time at the third temperature (T3) include 5 seconds to 60 minutes, 30 seconds to 60 minutes, or 10 to 40 minutes. Alternatively, the coating part forming composition may be stored while being maintained at the third temperature (T3) until use.

Step (d)

The step (d) is a step of coating a part of the base substance with the coating part forming composition obtained in the step (c).

A method of coating the part of the base substance with the coating part forming composition obtained in the step (c) is not particularly limited, and a known method can be used. Examples of such a method include a method using a decorator.

For example, the part of the base substance can be coated with the coating part forming composition by discharging the coating part forming composition from above to the base substance transported by the conveyor, with a decorator.

A nozzle diameter of the decorator may be appropriately adjusted according to the size of the base substance, and examples thereof include approximately φ0.5 to 2 mm (for example, approximately φ0.75 mm). Moving of the nozzle of the decorator is not particularly limited, and the nozzle of the decorator may move to an ellipse direction with respect to an advancing direction of the conveyor, from the viewpoint of coating efficiency. During discharging the coating part forming composition, it is preferable that the vicinity of a discharge part of the decorator is maintained at approximately the third temperature (T3).

The coating part is formed only on an upper surface of the base substance by discharging the coating part forming composition from above to the base substance. After forming the coating part on the upper surface of the base substance, the base substance is reversed and the coating part forming composition is discharged to a back surface of the base substance. Accordingly, the coating part can also be formed on the back surface of the base substance.

A shape of the coating part of the pet food produced by the production method according to the present embodiment is defined by a coating shape in this step. The coating shape can be controlled by, for example, the operation of the decorator, and the base substance can be coated with the coating part forming composition in various shapes such as a line shape, a dot shape, a circular shape, and a polygonal shape. From the viewpoint of production efficiency, it is preferable to form the coating part in the line shape.

Since the coating part forming composition used in this step is used in the steps (a) to (c), the shape retention property is good, and when applied to the base substance in this step, spreading or bleeding on the base substance is prevented from occurring. Therefore, a coating part having an appropriate height can be formed, and the coating part can be easily formed into a desired shape.

Base Substance

The base substance used in this step is not particularly limited, and any method can be used.

The shape of the base substance is not particularly limited, and any shape such as a granular shape, a rod shape, a plate shape, a spherical shape, a tubular shape, a cylindrical shape, and a conical shape can be adopted. Examples of a sectional shape of the base substance include a circle, an ellipse, a polygon (such as a triangle, a quadrangle, a pentagon, a hexagon, a rhombus, and a trapezoid), a star shape, and a heart shape, but are not limited thereto. In a case where the base substance is granular, examples of the shape of the granule include a circle, an ellipse, a polygon (such as a triangle, a quadrangle, a pentagon, a hexagon, a rhombus, and a trapezoid), a heart shape, a star shape, a cross shape, a donut shape, and a clover shape, but are not limited thereto.

The size of the base substance is not particularly limited as long as pet easily eats. For example, in a case where the pet food is granular, as the size of the pet food granule, for example, both the major axis and the minor axis are preferably within the range of 3 to 30 mm, more preferably 6 to 16.5 mm, and still more preferably 8 to 13 mm. For example, a thickness of the pet food granule is preferably 2 to 8 mm, more preferably 3 to 6 mm, still more preferably 3.5 to 5.5 mm, and particularly preferably 3.5 to 5 mm.

The base substance may have at least one recessed part. The disposition, a shape, and the number of the recessed part are not particularly limited, and any disposition, any shape, and any number can be adopted. When the base substance has the recessed part, the coating part is prevented from being peeled off. Also, in a case where the pet food is hard dry food, pet food becomes easy to chew by the presence of the recessed part. The recessed part may be a through-hole or a non-through-hole, and is preferably a through-hole from the viewpoint of being easy to chew.

Examples of a shape of the recessed part include a circle, an ellipse, a polygon (such as a triangle, a quadrangle, a pentagon, a hexagon, a rhombus, and a trapezoid), and a groove shape. The number of the recessed parts is not particularly limited, and examples thereof include 1 to 10, 2 to 8, 4 to 8, or 6 to 8. In a case where there are a plurality of recessed parts, examples of the disposition thereof include a lattice shape, a grid shape, a radial shape, a circular shape, an elliptical shape, and a polygonal shape (such as a triangle, a square, a pentagon, a hexagon, a rhombus, and a trapezoid).

As the base substance, known ingredients of pet food can be appropriately used. The base substance can be obtained, for example, by heating and forming a mixture of the ingredients, obtained by mixing the powder ingredient and the liquid ingredients. The base substance may be a puffed granule or a non-puffed granule, and is preferably the puffed granule from the viewpoint of food texture.

The “puffed granule” indicates a granule obtained by forming a mixture of the ingredients into a granular shape and also indicates a granule obtained by performing a puffing step of foaming inside the mixture of the ingredients. The “puffing step” indicates a step of generating a gas in the mixture of the ingredients using a technique of carrying out heating, fermentation, a chemical reaction, or pressure reduction. In the puffing step, as a gas is generated, the volume of the ingredient mixture is increased so as to have porous properties. Further, as the volume of the mixture of the ingredients is increased, the bulk density thereof is decreased. Before, after, or at the same time with the puffing step, the “puffed granule” is obtained by forming the mixture of the ingredients in a granular shape. The “non-puffed granule” indicates a granule produced without performing the puffing step.

Examples of powder ingredients include, as major ingredients, cereals (such as corn, wheat, rice, corn gluten meal, wheat bran, bread crumbs, barley, buckwheat, and rye), potatoes (such as sweet potatoes and potatoes), beans (such as round soybeans and defatted soybeans), starches (such as wheat starch, corn starch, rice starch, potato starch, tapioca starch, sweet potato starch, sago starch, and modified starch), meats (such as livestock such as chicken, beef, pork, and venison; liver, beef muscle, pork ears, and chicken fillet which represent part thereof; chicken meal, pork meal, beef meal, mixed meal of these, and meat extract which are processed product thereof), seafoods (such as fish such as tuna, bonito and horse mackerel; crustaceans such as shrimp and crab, molluscs such as octopus and squid, shellfish such as scallops and fish; fish meal, fish extract, and Katsuobushi which are processed product thereof; and small fish representing a form thereof, anchovy, a white fish representing a quality thereof, and tuna Chiai representing a part thereof), vegetables, seeds, mushrooms, fruits, algae, eggs, sugars, milks, and others (herbs, yeast, cellulose, and the like), and as additives, vitamins, inorganic salts, amino acids, acidulants, seasonings, flavors, coloring agents, preservatives, emulsifiers, and antioxidants.

Examples of the liquid ingredients include water, oils and fats, sugars (such as liquid sugar), humectants, preservatives, and emulsifiers. The humectant and the emulsifier may be added in a state of aqueous solution.

The oil and fat may be vegetable oil and fat or animal oil and fat. It is preferable to use the animal oil and fat from the viewpoint that high palatability is easily obtained. Preferred examples of the animal oil and fat include chicken oil, hog fat (lard), beef tallow (vet), and milk fat.

As a mixing example of the base substance, a total of 20% to 70% by mass of cereals, a total of 10% to 50% by mass of meat, a total of 0% to 30% by mass of seafoods, a total of 0% to 10% by mass of vitamins, minerals, and amino acids, 0% to 15% by mass of cellulose powder, and 1% to 20% by mass of animal oil and fat may be used.

Production Example of Base Substance

A method of producing the base substance is not particularly limited, and a known method can be used. In the following, a production method in a case where the base substance is the puffed granule is exemplified.

Granulating Step

In a granulating step, the mixture of the ingredient is granulated to obtain pet food granules. Known methods can be used as the method of mixing ingredients to obtain a mixture of the ingredients and the method of forming (granulating) the mixture of the ingredients in a granular shape.

For example, a method of producing puffed granules using an extruder can be suitably used.

As a method of producing puffed granules using an extruder, for example, a method described in “Small Animal Clinical Nutrition 5th Edition” (edited by Michael S. Hand, Craig D. Thatcher, Rebecca L. Remillard, Philip Roudebusg, and Bruce J. Novotny, published by Mark Morris Associates; 2014; p 209 to 215) or the like can be used.

An example of the method of producing puffed granules using an extruder is as follows. First, in the ingredients of puffed granules, ingredients other than external additives are pulverized as necessary and mixed. The ingredients may be mixed while being pulverized using a grinder or the like. Further, water (which is not included in the ingredient composition) is added thereto as necessary to obtain a mixture of the ingredients.

The obtained mixture of the ingredients is put into the extruder, heated, pressed, and extruded from an outlet. The outlet is provided with a plate in which a hole having a predetermined shape is formed and a cutter cutting the mixture of the ingredients extruded from the plate to have a predetermined length (thickness). At the same time with the extrusion of the mixture of the ingredients from the hole in the plate and the formation of the mixture in a predetermined shape by cutting the mixture using a cutter, the mixture of the ingredients are released to the atmospheric pressure from the pressurized state so that water vapor in the mixture of the ingredients expands, and the mixture of the ingredients is puffed, thereby obtaining porous granules.

Drying Step

The granules to be obtained in the above-described manner are dried as necessary until a predetermined moisture content is obtained to obtain puffed granules (food granules). In a case where dry type food granules are produced, the drying step is indispensable.

For example, the moisture content of granules to be discharged from the extruder is in a range of 10% to 20% by mass. In a case where the moisture content of the granules is in the above-described range, excellent formability is likely to be obtained.

The temperature of granules to be discharged from the extruder depends on the heating temperature in the extruder. For example, the temperature thereof may be in a range of 90° C. to 150° C.

As the method of drying the granules discharged from the extruder, a known method can be appropriately used. Examples of the known method include a hot air drying method of drying granules by blowing hot air to the granules; a vacuum drying method; and a method of frying granules in oil. For example, a hot air drying method using a conveyor type hot air dryer is preferable.

The drying conditions (the temperature and the time) may be conditions for increasing the temperature of granules to 100° C. or higher to evaporate the moisture in the granules without thermal denaturation of the components of the granules and adjusting the moisture content of the granules to a desired value.

For example, in a case where the granules are dried by a hot air dryer, the temperature of the hot air coming into contact with the granules is preferably in a range of 100° C. to 140° C. and more preferably in a range of 100° C. to 110° C. The drying time is particularly limited, and the granules are dried for approximately 5 to 20 minutes.

The pet food may be further coated with a coating agent containing crude beef tallow, a seasoning, or a flavoring agent after being dried.

The coating method is not particularly limited, and the pet food can be coated according to a vacuum coating method.

The vacuum coating method is a method of reducing the pressure in a state in which the heated food granules and the coating agent are in contact with each other or adhere to each other and slowly releasing the food granules to the atmosphere. The coating agent may be in a liquid or powder state. By coating the food granules with the coating agent, the palatability (biting property) for a pet can be improved.

Step (e)

The step (e) is a step of solidifying the coating part forming composition with which a part of the base substance is coated.

A method of solidifying the coating part forming composition is not particularly limited, and a known method can be used. Examples of such a method include cooling. In cooling, a temperature may be lowered to a solidification temperature of the coating part forming composition, and the cooling temperature may be selected according to the composition of the coating part forming composition. Examples of the cooling temperature include 30° C. or lower, 25° C. or lower, or 15° C. or lower. The coating part forming composition can be solidified even at room temperature, but in order to shorten the time until the solidification, cooling may be performed by a spot cooler or the like.

Optional Step

The production method according to the present embodiment may include an optional step in addition to the steps (a) to (e). Examples of the optional step include a connection breaking step.

The connection breaking step is a step of breaking a chunk of pet food joined by the coating part forming composition. The connection breaking can be performed by giving an impact to the base substance. A method of giving the impact is not particularly limited, and examples thereof include a method of loosening the connection using a ladder chute or the like and a method of applying vibration. The connection breaking step may be performed between the step (d) and the step (e) or after the step (e), and may be performed between the step (d) and the step (e) and after the step (e).

Pet Food

The pet food produced by the production method according to the present embodiment includes the base substance and the coating part that coats a part of the base substance. The base substance is not completely coated with the coating part, and a part of the base substance is exposed.

Since the coating part of the pet food is formed by the coating part forming composition prepared by the steps (a) to (c), the shape retention property thereof is good and an appropriate height thereof is kept. The height of the coating part (the height from the surface of the base substance to the topmost part of the coating part) is not particularly limited. For example, the height can be 0.1 to 2 mm, and from a viewpoint of balance between the appearance with the base substance and the food texture, the height is preferably 0.5 mm to 2 mm.

The shape of the coating part is not particularly limited, and is preferably a line shape as shown in FIG. 1 from the viewpoint of production efficiency. For example, in a case where the pet food is granular, the coating part may be formed so as to cross or longitudinally cross the pet food granule. The shape of the coating part is not limited to a line shape, and may be a dot shape, a circular shape, a polygonal shape, or the like, and various shapes can be selected according to the shape of the base substance.

In a case where the coating part has the line shape, the width of the coating part having the line shape can be controlled by the nozzle diameter of the decorator or the like used in the step (d). The width of the coating part having the line shape can be, for example, 0.1 to 10 mm, 0.5 to 5 mm, 1 to 5 mm, or 1 to 3 mm. In the production method according to the present embodiment, since the coating part forming composition prepared by the steps (a) to (c) is used, the shape retention property of the coating part is good and bleeding or spreading on the base substance are prevented from occurring. Therefore, the width of the coating part can be easily controlled.

The pet food produced by the production method according to the present embodiment is preferably a dry type or a soft type of pet food, and more preferably the dry type pet food. The pet food may be a comprehensive nutritious food or a snack. In the pet food produced by the production method according to the present embodiment, since the coating part is formed using the coating part forming composition prepared by the steps (a) to (c), the shape retention property of the coating part is good and bleeding to the base substance is prevented from occurring. This makes it possible to produce pet food that is excellent in appearance with a small amount of the coating part forming composition. Therefore, even in a case of using ingredients with high palatability for the coating part, the appearance of pet food can be improved without impairing the nutritional balance of the pet food as a whole. Therefore, the method of producing pet food according to the present embodiment is suitable for producing a comprehensive nutritious food having an excellent appearance.

According to the method of producing pet food according to the present embodiment described above, the coating part forming composition is prepared by the steps (a) to (c), and the coating part is formed using the coating part forming composition. Therefore, the shape retention property of the coating part is improved, and bleeding or spreading can be prevented from occurring to form a coating part having an appropriate height. This is presumed that because a stable crystal structure is formed in the coating part forming composition by performing the steps (a) to (c). According to the production method according to the present embodiment, since the shape retention property of the coating part is improved, pet food excellent in appearance can be produced.

It is possible to confirm whether the pet food having the coating part that coats a part of the base substance is produced by the production method of the present embodiment, for example, by analyzing a crystal structure of the oil and fat in the coating part by X-ray diffraction. In crystals in the oil and fat, there are those having the same composition but having different sublattice structures (crystal structures), called crystal polymorphs. Typically, there are hexagonal types, orthorhombic vertical types, and triclinic parallel types, which are called an a type, a β′ type, and a β type, respectively, and the β type has the most stable crystal structure. If the composition of the oil and fat and the melting point of each polymorph are known, it is possible to detect at least whether the β-type oil and fat is present in the oil and fat.

A general method for identifying polymorphs of the crystal structure of the oil and fat is an X-ray diffraction method, and diffraction conditions are given by the following Bragg equation.

2d sin θ=nλ (n=1,2,3 . . . )

A diffraction peak appears at a position satisfying the equation. Here, d represents a lattice constant, θ represents a diffraction (incident) angle, A represents an X-ray wavelength, and n represents a natural number. Information on a side packing (sublattice) in the crystal is obtained from a diffraction peak 2θ=16 to 27° corresponding to a short face interval, and polymorphs can be identified. The X-ray diffraction measurement can be performed using, for example, an X-ray diffraction apparatus maintained at 20° C. The most commonly used X-ray light source is CuKα ray (1.54 Å). It is presumed that the coating part of pet food produced by the production method of the present embodiment has a large amount of β-type oils and fats.

Furthermore, the polymorphs of the oil and fat can also be predicted by a differential scanning calorimetry method (DSC method). For example, the prediction of the β-type oil and fat is performed by predicting the crystal structure of the oil and fat based on the DSC curve obtained by raising the temperature to 100° C. at a temperature increasing rate of 10° C./min using a differential scanning calorimeter.

### EXAMPLES

The present invention will be described in more detail with reference to the following example, but the present invention is not limited to these examples. Hereinafter, “%” indicates “% by mass” unless otherwise noted.

### Example 1

Production of Base Substance

The ingredients of the base substance were mixed in the formulation shown in Table 1. The obtained mixture of the ingredients was put into an extruder and heat-treated at approximately 115° C. for approximately 2 minutes while kneading to pregelatinize starch components, and extruded and granulated into a granular shape at an outlet of the extruder and puffed at the same time. At the outlet of the extruder, kneaded matter was extruded into a column shape from the hole having a predetermined shape, and the columnar matter was cut with a cutter so as to have a thickness of 4 mm to obtain granular matter.

The obtained granular matter is dried at approximately 100° C. for 5 to 20 minutes using a dryer, and then coated with an external additive (1.5% oil coating) to obtain a base substance which is a dry type puffed granule.

TABLE 1

| Ingredients | Mass (%) |
|---|---|
| Cereals | 40% |
| Meats | 40% |
| Seafoods | 4% |
| Yeasts | 3% |
| Vitamins, minerals, and | 3% |
| amino acids | |
| Animal oil and fat | 10% |

Production of Pet Food

Table 2 shows the formulation of the coating part forming composition.

TABLE 2

| Ingredients | Mass (%) |
|---|---|
| Vegetable oil and fat | 30% |
| Hardened oil and fat | 20% |
| Soy protein | 40% |
| Dextrin | 10% |

Step (a)

Vegetable oil and fat and hardened oil and fat were put into a cylindrical pot and warmed to 60° C. or higher (mixture 1). Soy protein and dextrin were mixed (mixture 2). The mixture 2 was added to the mixture 1 to form a coating part forming composition. The addition was performed while stirring with a Homo disper, and the coating part forming composition was processed at 58° C. or higher. The temperature of the coating part forming composition was confirmed by measuring with a contact thermometer.

Step (b)

The coating part forming composition was cooled to 50° C. to 54° C.

Step (c)

The coating part forming composition was warmed to 54.5° C. to 57° C. to obtain a prepared coating part forming composition (1).

Step (d)

The coating part forming composition (1) was put into a decorator, the decorator was reciprocated in an elliptical direction, and the coating part forming composition was sprinkled on the base substance from above to coat a part of the base substance with the coating part forming composition.

Step (e)

The base substance partially coated with the coating part forming composition was cooled to 20° C. to 30° C. to obtain pet food P1 having a coating part.

### Comparative Example 1

Production of Base Substance

A base substance was produced in the same manner as in Example 1.

Production of Pet Food

The formulation of the coating part forming composition was as shown in Table 2. Vegetable oil and fat and hardened oil and fat were put into a cylindrical pot and warmed to 60° C. or higher (mixture 1). Soy protein and dextrin were mixed (mixture 2). While adding the mixture 2 to the mixture 1, the mixture was stirred with a Homo disper for 10 to 15 minutes. The obtained mixture was passed through a sieve (hole 710 μm) to obtain a coating part forming composition (2). The coating part forming composition (2) was stored in a storage tank kept at 40° C. to 70° C.

Except that the coating part forming composition (2) is used instead of the coating part forming composition (1), the steps (d) and (e) are performed in the same manner as in Example 1 to obtain pet food P2 having a coating part.

Width and Height of Coating Part

In accordance with the method described in “Method of measuring height and width of coating part”, the width and height of the coating part of the pet food of each example were measured. The results are listed in Table 3.

Bleeding of Coating Part Forming Composition to Base Substance

The pet food of each example was visually observed, and the bleeding of the coating part forming composition to the base substance was evaluated according to the following evaluation criteria. The results are listed in “Bleeding” in Table 3.

Evaluation Criteria of Bleeding

A: There is no bleeding of coating part forming composition to base substance

B: There is bleeding of coating part forming composition to base substance

TABLE 3

| | Width of coating part | Height of coating part | |
|---|---|---|---|
| | (mm) | (mm) | Bleeding |
| Example 1 | 1.42 | 0.97 | A |
| Comparative | 4.68 | 0.41 | B |
| Example 1 | | | |

As shown in Table 3, in Example 1, it was confirmed that a coating part having a narrower width and a higher height compared to Comparative Example 1 was formed. In addition, no bleeding of the coating part to the base substance was observed. This result shows that the coating part forming composition used in Example 1 has an excellent shape retention property and can form a coating part that is excellent in appearance.

On the other hand, in Comparative Example 1, the spreading or bleeding of the coating part on the base substance was observed, and the height of the coating part could not be maintained. This result shows that the shape retention property of the coating part forming composition used in Comparative Example 1 is low.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Pet food
10 Base substance
11 Recessed part
20 Coating part

What is claimed is:

1. A method of producing pet food including a base substance and a coating part that coats a part of the base substance, in which a part of the base substance is exposed and a component composition of the base substance and a component composition of the coating part are different from each other, the method comprising:
(a) a step of processing a coating part forming composition having a composition different from that of the base substance, at a first temperature (T1);
(b) a step of processing the coating part forming composition at a second temperature (T2), after the step (a);
(c) a step of processing the coating part forming composition at a third temperature (T3), after the step (b);
(d) a step of coating a part of the base substance with the coating part forming composition obtained in the step (c); and
(e) a step of solidifying the coating part forming composition with which the part of the base substance is coated,
wherein there is a relationship of the first temperature (T1)>the third temperature (T3)>the second temperature (T2).

2. The method of producing pet food according to claim 1,
wherein the first temperature (T1) is a temperature equal to or higher than a melting point of the coating part forming composition,
the second temperature (T2) is in a temperature range of 42° C. to 58° C., and
the third temperature (T3) is in a temperature range of 42.5° C. to 60° C.

3. The method of producing pet food according to claim 1,
wherein the coating part forming composition contains oil and fat and a powder ingredient.

4. The method of producing pet food according to claim 1,
wherein the coating part forming composition contains hardened oil and fat.

5. The method of producing pet food according to claim 1,
wherein a temperature difference between the second temperature (T2) and the third temperature (T3) is in a range of 0.5° C. to 5° C.

6. The method of producing pet food according to claim 1,
wherein a temperature difference between the first temperature (T1) and the second temperature (T2) is in a range of 7° C. to 20° C.

7. The method of producing pet food according to claim 1,
wherein a height from a surface of the base substance to a topmost part of the coating part is 0.1 to 2 mm.

8. The method of producing pet food according to claim 1,
wherein the base substance is granular.

9. The method of producing pet food according to claim 8,
wherein the base substance is a puffed granule.
